(19) United States
(12) Patent Application Publication
(10) Pub. No.: US 2016/0381533 A1
(43) Pub. Date: Dec. 29, 2016

(54) SYSTEM AND METHOD FOR EFFECTIVE COMMUNICATION ACROSS A PLURALITY OF COMMUNICATION MODALITIES

(71) Applicant: THOMSON LICENSING, Issy de Moulineaux (FR)

(72) Inventor: Joel Mitchell Fogelson, Pasadena, CA (US)

(21) Appl. No.: 14/753,491

(22) Filed: Jun. 29, 2015

(51) Int. Cl. H04W 4/18; H04L 12/58

(52) U.S. Cl. CPC H04W 4/18; H04L 51/32; H04L 51/063; H04L 51/066

(57) ABSTRACT

A system and method for effective communication across a plurality of communication modalities are provided. The present disclosure provides for a communication platform (116) that determines the most effective communication modality for communication with a particular user based on a plurality of factors, such as, but not limited to, the time of the communication, the communication history with the particular user, and any stored preferences. Additionally, the present disclosure provides for a content filter (222) for filtering inappropriate content of a communication to a user based on factors such as, but not limited to, the communication modality used, the location of the sender, and the relationship of the sender to the recipient.

### TECHNICAL FIELD

The present disclosure relates to electronic communications, and more particularly, to a system and method for effective communication across a plurality of communication modalities.

### BACKGROUND

In modern times, it is possible to communicate with an acquaintance, friend, or colleague through a number of communication modalities (e.g., text message, email, phone call, social networking, a social photo sharing service, etc.). One issue with having a variety of possible communication modalities available is that some communication modalities may be more effective for reaching certain people under certain circumstances, while other communication modalities may be less effective. For example, some people may respond more quickly to a text message sent to their phone, while other people may respond more quickly to an email or a social networking message. Furthermore, the way a particular person responds may depend on the time of day they are contacted. For example, in the morning a person may respond more quickly to an email, while at night a person may respond more quickly to a text or phone call.

Another issue with having a variety of possible communication modalities is that certain content within a particular communication may be inappropriate for one communication modality (e.g., a work email), while the same content may be appropriate for another communication modality (e.g., text message to personal phone).

With the ever-increasing pace of electronic communication between users, it can be difficult to find an effective and appropriate way to communicate across the wide array of communication modalities available today.

### SUMMARY

A system, method and apparatus for effective communication across a plurality of communication modalities are provided.

According to one aspect of the present disclosure, a communication method is provided including analyzing a communication to be sent from a first user using a first communication modality to at least a second user, the second user having at least a first contact option using the first communication modality and a second contact option using a second communication modality, determining, based on at least a first parameter, if the communication should be transmitted to the first contact option or the second contact option, transmitting the communication to the first contact option if it is determined that the communication should be sent to the first contact option, converting the communication from a first format to a second format if it is determined that the communication should be sent to the second contact option, the first format compatible with the first communication modality and the second format compatible with the second communication modality, and transmitting the communication to the second contact option if it is determined that the communication should be sent to the second contact option.

According to another aspect of the present disclosure, a communication platform includes a routing module that analyzes a communication to be sent from a first user using a first communication modality to at least a second user, the second user having at least a first contact option using the first communication modality and a second contact option using a second communication modality, the routing module determines, based on at least a first parameter, if the communication should be transmitted to the first contact option or the second contact option and transmits the communication to the first contact option if it is determined that the communication should be sent to the first contact option, and a formatting module that converts the communication from a first format to a second format if it is determined by the routing module that the communication should be sent to the second contact option, the first format compatible with the first communication modality and the second format compatible with the second communication modality, wherein the routing module transmits the communication to the second contact option if it is determined by the routing module that the communication should be sent to the second contact option.

According to another aspect of the present disclosure, a communication method includes analyzing a communication to be sent from a first user to at least a second user, the second user having at least a first contact option and a second contact option, determining if the communication contains content that would be objectionable to receive at either the first contact option or the second contact option, transmitting the communication to the first contact option if there is no objectionable content for the first contact option, transmitting the communication to the second contact option if there is objectionable content for the first contact option and there is not objectionable content for the second contact option, proposing alternative content if there is objectionable content for the first and second contact options, and transmitting the communication to at least one of the first and second contact options if the objectionable content is replaced by the alternative content.

According to another aspect of the present disclosure, a communication platform includes a content filter module that analyzes a communication to be sent from a first user to at least a second user, the second user having at least a first contact option and a second contact option, determines if the communication contains content that would be objectionable to receive at either the first contact option or the second contact option, transmits the transmission of the communication to the first contact option if there is no objectionable content for the first contact option and transmits the transmission of the communication to the second contact option if there is objectionable content for the first contact option and there is not objectionable content for the second contact option, and a word suggestion module that proposes alternative content if there is objectionable content for the first and second contact options, wherein the content filter module transmits the communication to at least one of the first and second contact options if the objectionable content is replaced by the alternative content.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

FIG. 1 is a block diagram of a communication system in accordance with the present disclosure;

FIG. 2 is a block diagram of a communication platform in accordance with the present disclosure;

FIG. 3 is flowchart for an exemplary method for sending messages using a communication platform in accordance with the present disclosure;

FIG. 4 is flowchart for an exemplary method for receiving messages using a communication platform in accordance with the present disclosure;

FIG. 5A is a block diagram of an exemplary group messaging communication using a communication platform in accordance with the present disclosure;

FIG. 5B is another block diagram of an exemplary group messaging communication using a communication platform in accordance with the present disclosure;

FIG. 6 is a block diagram of a content filter module in accordance with the present disclosure; and

FIG. 7 is a flowchart of an exemplary method for filtering objectionable content in accordance with the present disclosure.

It should be understood that the drawings are for purposes of illustrating the concepts of the disclosure and is not necessarily the only possible configuration for illustrating the disclosure.

### DESCRIPTION OF EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for instructional purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor”, “module” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present disclosure provides for a communication platform that determines the most effective communication modality for communication with a particular user based on factors such as, but not limited to, the time of the communication, the communication history with the particular user, and any stored preferences. Additionally, the communication platform can convert outgoing and incoming communications to the proper and/or desired format based on the communication modality that is determined to be the most effective for communication with a particular user. The communication platform can be used for group messaging to separately establish the most effective communication modalities for each of the users in the group message. Also, the communication platform can learn and adapt, based on various information gathered and stored, what the most effective communication modality for contacting a particular user is.

Additionally, the present disclosure may provide a communication platform to filter the inappropriate content (i.e., words and topics) of a communication to a user based on the communication modality used, the location of the sender, and the relationship of the sender to the recipient. The communication platform of the present disclosure can be used to find the appropriate communication modality for a particular user based on the content in a communication. Also, the communication platform of the present disclosure can be used to suggest alternative content if it is determined that the communication contains inappropriate content for all available communication modalities.

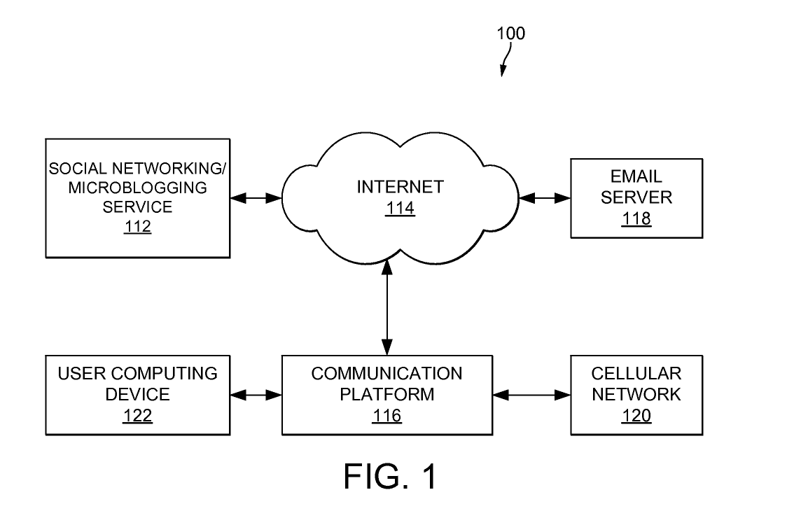

Turning to FIG. 1, a block schematic diagram of a communication system 100 in accordance with an embodiment of the present disclosure is shown. The system 100 includes a social media communication service 112, the Internet 114, an email server 118, a user computing device 122, a communication platform 116, and a cellular network 120. More specifically, the system 100 of FIG. 1 shows user computing device 122 coupled to communication platform 116, where communication platform 116 is further coupled to cellular network 120 and Internet 114. Internet 114 is coupled to email server 118 and social media communication service 112. It is to be appreciated that, in some embodiments, communication platform 116 may be disposed in user computing device 122, while in other embodiments, communication platform 116 may be disposed outside of user computing device 122 as shown in FIG. 1.

As stated above, system 100 includes social media communication service 112. Social media communication service 112 includes social networking services such as, but not limited to, Twitter™, Facebook™, Google+™, photo sharing services, such as, Instagram™, video sharing services, such as, Snapchat™, etc. It is to be appreciated that social media communication service 122 may include any social media platform that enables users to share content or communicate via an online network. For many of these social media services, users may send and receive messages that are public (i.e., for many users on the social media platform to see) or private (i.e., sent directly to another user of the social media platform).

User computing device 122 may be any number of computing devices used for communicating across various communication modalities, such as, but not limited to, smart phones, tablets, personal computers, video game systems, personal communicators, and laptops. For example, user computing device 122 may be a personal computer or laptop used for sending and receiving emails via Internet 144 and email server 118 or sending and receiving messaged via social media communication service 112. Furthermore, user computing device 122 may be a smart phone capable of sending/receiving emails, social media messages, texts messages, phone calls, etc. It is to be appreciated that user computing device 122 may include an email client for communication with email server 118, or alternatively a web-based email may be used (e.g., Gmail, AOL, Yahoo, Hotmail, etc.).

Cellular network 120 is also shown in FIG. 1. It is to be appreciated that cellular network 120 may be any well-known cellular network (e.g., AT&T, Verizon, Sprint, T-Mobile, etc.) that is being used with user computing device 122 to communicate with other user computing devices. For example, if user computing device 122 is a smartphone using AT&T, cellular network 120 represents the AT&T cellular network.

As stated above, with a plurality of communication modalities (such as social media communication service 112, email server 118, and cellular network 120) available to modern day user, many new challenges for effective communication exist. One potential challenge is determining the most effective communication modality to use when contacting a user at a particular time of the day. For example, one user may respond to emails more quickly than texts or social media messages in the morning, while the same user may respond more quickly to texts than social media messages and emails in the evening. Furthermore, the same user may respond more quickly to social media messages than emails and texts on the weekends. In accordance with an embodiment of the present disclosure, communication platform 116, shown in FIG. 1, is configured to provide a solution to the above-described problem created by the existence of the various communication modalities.

Communication platform 116 is configured to send and receive all communication intended to be sent and received by user computing device 112. For example, in FIG. 1, communication platform is configured to intercept messages sent from user computing device 122 to email server 118 (i.e., emails), social media communication service 112 (e.g., tweets, FB messages, etc.), and cellular network 120 (i.e., text messages). It is to be appreciated that communication platform 116 is also configured to send and receive instant messaging communication modalities, such as Gchat, Facebook messenger, AOL Instant Messenger, etc. Furthermore, communication platform 116 is configured to process and filter the messages to determine the most effective communication modality to use for the messages to be sent. Below, communication platform 116 will be described in greater detail in accordance with the present disclosure.

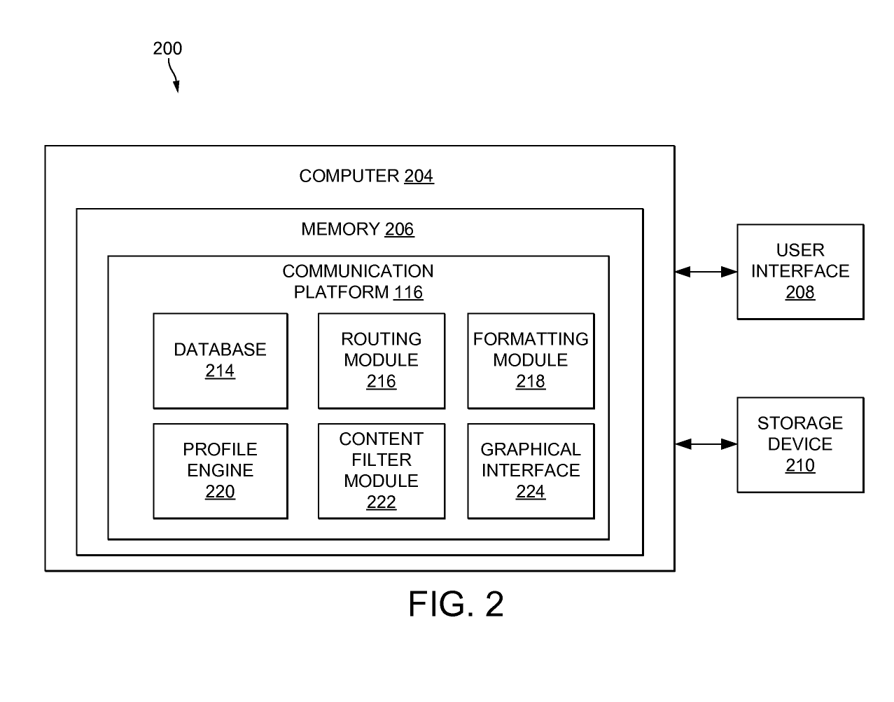

Referring to FIG. 2, exemplary components of the communication platform 116, embodied as apparatus 200, are shown. Messages intended to be received and/or transmitted to user computing device 122 are input to a processing device 204, e.g., a computer. As stated above, although processing device 204 is described as a computer in reference to FIG. 2 and shown as being coupled to user computing device 122, processing device 204 may be disposed inside user computing device 122. For example, processing device 204 may be one of many of the components of a smartphone or tablet.

Processing device 204 is implemented on any of the various known computer platforms having hardware such as one or more central processing units (CPU), memory 206 such as random access memory (RAM) and/or read only memory (ROM) and input/output (I/O) user interface(s) 208 such as a keyboard, cursor control device (e.g., a mouse or joystick) and display device. The computer platform also includes an operating system and micro instruction code. The various processes and functions described herein may either be part of the micro instruction code or part of a software application program (or a combination thereof) which is executed via the operating system. In one embodiment, the software application program is tangibly embodied on a program storage device, which may be uploaded to and executed by any suitable machine such as user computing device 122 or communication platform 116. In addition, various other peripheral devices may be connected to the computer platform by various interfaces and bus structures, such a parallel port, serial port or universal serial bus (USB). Other peripheral devices may include additional storage devices 210.

As seen in FIG. 2, communication platform 116 is stored on memory 206 in computer 204. Communication platform 116 includes database 214, routing module 216, formatting module 218, profile engine 220, content filter module 222, and graphical interface 224. Database 214 in communication platform 116 is used to store information associated with prior communication between a user and other users. For example, one type of information stored in database 214 is a history file that has recorded communications between a user using communication platform 116 and other users. The history file contains information associated with the user who was contacted, the time of date a communication took place, the communication modality used to contact the user, and any user preferences saved (e.g., a user has indicated they prefer to be contacted using a specific communication modality). It is to be appreciated that the information described above as being included in database 214 is only a small subset of the possible information that may be recorded in association with a user's communications with other users and that other statistics associated with user communications may be recorded in database 214 as well. For example, in some embodiments return delivery receipts for each communication modality are saved.

Profile engine 220 processes the information stored in database 214 to determine patterns associated with how specific users respond to communications using different communication modalities at different times of the day. For example, profile engine 220 can compare communications sent by a user A to a user B between 9 AM and 11 AM via text message to communications sent by user A to user B between 9 AM and 11 AM sent via email to determine, on average, when user B responds more quickly to user A. In addition, profile engine 220 can see if the day of the week effects how quickly user B responds to user A. Profile engine 220 performs these comparisons for a predetermined combination of times, communications modalities, and days of the week to determine what user B's response patterns to communication received by user A are. Any response patterns discerned by profile engine 220 are then stored in a contact profile (in this example, user B's contact profile). Profile engine 220 will perform many comparisons for all of user A's contacts, cross-referencing the information stored in database 214, to create contact profiles for all of user A's contacts. The contact profiles are stored in database 214. Profile engine 220 can be implemented to recognize patterns of user data using preprogrammed rules, machine learning processes, and the like.

It is to be appreciated, that profile engine 220 can perform many different comparisons using information stored in database 214, and the above described example is merely one example of a few possible comparisons that profile engine 220 can perform. For example, profile engine 220 may compare what communication modality user B chooses to use when user B initiates communication with user A. Furthermore, profile engine 220 may analyze return delivery receipts from various communication modalities used by user B to compare how quickly user B opens user B's messages after the messages are sent in different circumstances using different communication modalities.

Also included in communication platform 116 is routing module 216. Routing module 216 is configured to check database 214 when a user attempts to send a message to another user to see which communication modality communication platform 116 (via database 214 and profile engine 220) has determined is best to use to send the message given the time, date, and user to be contacted. Furthermore, routing module 216 is configured to send the message using the communication modality that is determined to be best by communication platform 116. For example, if user A sends an email to user B, routing module 216 will check user B's contact profile in database 214 to see what the best way to contact user B is given the information stored in user B's contact profile. If the best communication modality to contact user B is the same communication modality as that used originally by user A (i.e., the best communication modality in the current example is an email) then routing module 216 will transmit the message using the appropriate communication modality (i.e., to email server 118 in the current example). It is to be appreciated that in some embodiments routing module 216 is configured to send messages directly using the appropriate communication modality, while in other embodiments, routing module 216 is configured to send the message back to user computing device 122, so that user computing device 122 can complete the transmission of the message using the appropriate communication modality.

Returning to the example being described above, if the best communication modality to contact user B (as determined by communication platform 116) is a different communication modality than that used originally by user A (e.g., the best communication modality is a text message instead of an email in the current example), then routing module 216 will transmit the message to formatting module 218 so that the format of the message can be adopted for the new communication modality (i.e., the message can be converted from an email to a text message in the current example). It is to be appreciated that formatting module 218 is configured to convert a message between different communication modality formats, such as, but not limited to, emails, text messages, and social media messages.

For example, the text of a text message may be converted into an email by formatting module 218. In an exemplary embodiment of a conversion between a text message and an email, there are a couple of operations that are performed by formatting module 218. The first operation can be a mapping between the identifying fields from the text message to the fields that are used in an email. That is, the text message is analyzed by formatting module 218 to determine the source of the text message and to whom the text message is to be communicated to. The source of the text may be a phone number which can be mapped to an email address, social media identifier, instant messenger identifier and the like using information in database 214 and/or formatting module 218. The destination of the text may also be a phone number that can be mapped to an email address, social media identifier, instant message identifier, and the like using information from database 214 and/or formatting module 218. The content of the text can then be extracted and is used as the body of the email by formatting module 218. For the “subject” of the email, the formatting module 218 can use “Text from ‘Sender’ using identifying information from the sender to complete the ‘Sender’ field. It is to be appreciated that the above described conversion process is merely exemplary and many other conversions between different types of messages can be performed by formatting module 218 in accordance with the presented disclosure.

As stated above, graphical interface 224 is also included in communication platform 116. Graphical interface 224 generates a graphical interface to be displayed on a user computing device 122. Although not shown, graphical interface 224 will contain various buttons and configuration options associated with the management of communication platform 116. Therefore, it is to be appreciated that graphical interface 224 will allow a user to interact with communication platform 116 by viewing and modifying various settings and preferences associated with communication platform 116. For example, if user A has been told by user B that user B prefers to be contacted by email during working hours, user A may store user B's preference in database 214 using a graphical interface 224 that is displayed on user computing device 122. It is to be appreciated that there are many possible modifications and configurations that can be made by a user using graphical interface 224 and that the above example is merely one possible usage of graphical interface 224.

It is to be appreciated that some or all of the information stored in communication platform 116 may be stored in a storage device 210 that is coupled to communication platform 116. It is further to be appreciated that storage device 210 may be coupled physically via hardwire connection to communication platform 116 or alternatively storage device 210 may be coupled wirelessly to communication platform 116. For example, storage device 210 may contain the information stored in database 214 and storage device 210 may be on a server at a different location than communication platform 116. The information stored in storage device 210 would be accessible by communication platform 116 via Internet 114. It may be advantageous to store contact profile information in a storage device 210 on a server accessible via the Internet 114 so that information from multiple user computing devices 122 used by the same user may be used to extract habits associated with a user's communications with other users. For example, storage device 210 may contain information associated with a user's communications using the user's smartphone, tablet, and computer. Information associated with communications sent and received on the user's smartphone, tablet, and computer can all be stored in a storage device 210 to provide profile engine 220 with a large amount of information for forming profile contacts for use with communication platform 116.

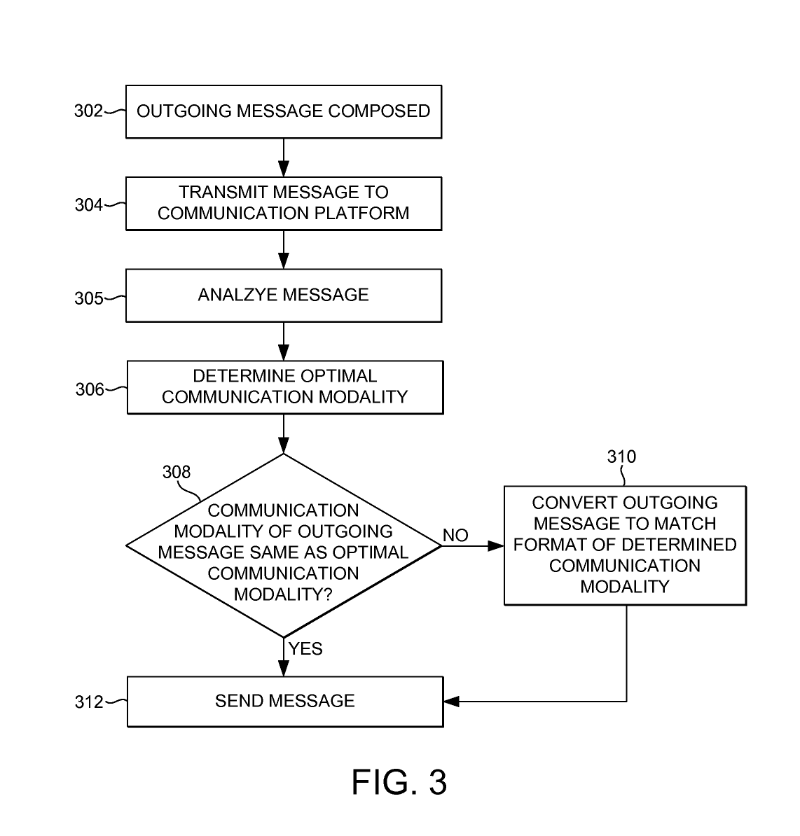

Turning to FIG. 3, an exemplary method for using communication platform 116 to send messages is shown in accordance with an embodiment of the present disclosure. Initially, an outgoing message is composed by user A for user B, in step 302. The outgoing message is composed on user computing device 122 in a communication modality chosen by user A. For example, the communication modality may be an email composed on a smartphone. The composed email is then transmitted to communication platform 116, in step 304. In communication platform 116, routing module 216 will analyze the message to extract or determine at least one parameter, e.g., the currently used communication modality, the intended recipient, etc., in step 305. The routing module 216 then uses the contact profile created for user B stored in database 214 to determine what communication modality is best to use to communicate with user B, in step 306. As stated above, the determination can be made based on information saved and analyzed concerning communications between user A and user B, such as, but not limited to, the day of the week, the time of day, the user being contacted, and any saved preferences.

After routing module 216 determines the best communication modality to use to contact user B, routing module 216 will determine if the communication modality that user A initially used to compose the message (i.e., email) is the same as the communication modality that routing module 216 determined is the best to use to communicate with user B, in step 308. If routing module 216 determines that the communication modality that user A used to compose the message is the same as the communication modality that routing module 216 determined is best to use to communicate with user B, routing module 216 will send the message via the determined communication modality (i.e., email), in step 312. However, if routing module 216 determines that the communication modality that user A used to compose the message is different than the communication modality that routing module 216 determined is best to use to communicate with user B, routing module 216 will transmit the composed message to formatting module 218, where formatting module 218 will convert the format of the composed message to match the format of the communication modality that was determined to be the best to use to contact user B, in step 310. Afterwards, routing module 216 will send the message in the converted format, in step 312.

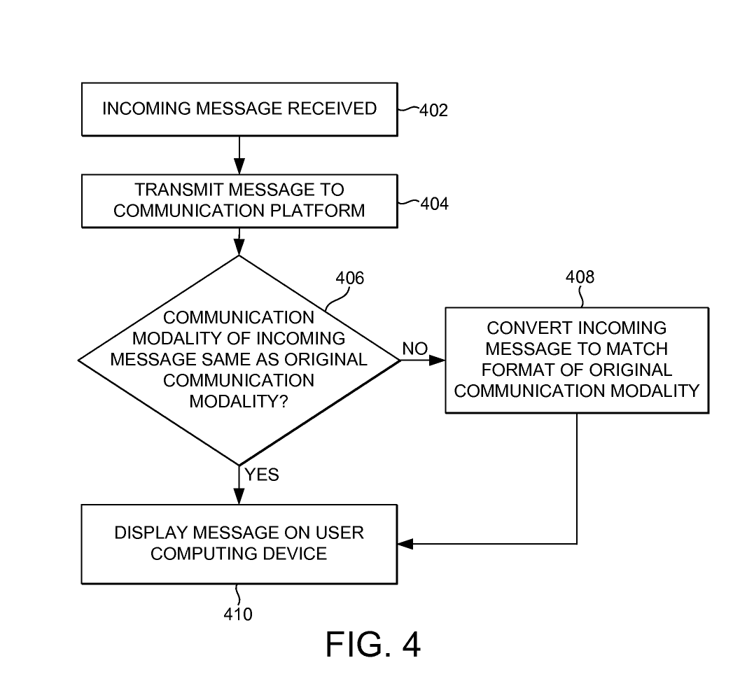

After user A's message is sent to user B, communication platform 116 can also be used to manage user B's response to user A. Turning to FIG. 4, an exemplary method for using communication platform 116 to receive messages is shown in accordance with an embodiment of the present disclosure. Initially, an incoming message from user B is received by user A's computing device 122, in step 402. It is to be appreciated that, in some embodiments, the incoming message may also be received by communication platform 116. Once received by user computing device 122, the incoming message is transmitted to communication platform 116, in step 404. In communication platform 116, database 214 will update and record any relevant information associated with user B's response in database 214. Once any relevant information is recorded in database 214, profile engine 220 can use the new information to update user B's contact profile. For example, database 214 can record how long it took user B to respond to user A's communication, what date the communication was sent and responded to, and what communication modalities were used.

After communication platform 116 has received user B's response to user A, routing module 216 will determine if the communication modality used for user B's response matches the communication modality originally chosen by user A when user A composed the original outgoing message, in step 406. If routing module 216 determines that the communication modality used for user B's response matches the communication modality originally chosen by user A when composing the original outgoing message, routing module 216 will transmit user B's response to user A's computing device 122 to be displayed on user A's computing device 122, in step 410. However, if routing module 216 determines that the communication modality used for user B's response does not match the communication modality originally chosen by user A when composing the original outgoing message, formatting module 218 will convert user B's response to a format that matches the communication modality originally chosen by user A when composing the original outgoing message, in step 408. Then, routing module 216 will transmit user B's response to user A's computing device 122 to be displayed on user A's computing device 122, in step 410.

For example, user A may send a message to user B in the form of an email, and the communication platform 116 may determine the best communication modality to be used to contact user B at that time is a text message. As describe above in relation to FIG. 3, communication platform 116 will convert (via formatting module 218) the email to a text message and send the message originally composed as an email by user A as a text message to user B. When user B receives the text message and responds to user A with another text message, communication platform 116 will receive user B's text message (i.e., the response) and convert the text message to an email. In this way, from user A's perspective, the conversation between user A is taking place in the communication modality chosen by user A (i.e., email), while simultaneously from user B's perspective, the conversation is taking place in a different communication modality that is more convenient for user B (i.e., text message).

It is to be appreciated that in another embodiment communication platform 116 can be configured to determine the best communication modality to be used for the original sender to receive a response and the response may be converted based on this determination. For example, from the example above, when user B responds in the form of a text message to user A's email, communication platform 116 may determine based on the date, time, and other relevant factors that the best communication modality for user A to receive user B's response is a social media message. As described above, communication platform 116 may receive user B's text message response and convert the text message to a social media message and transmit the social media message to user A. In this way, communication platform 116 ensures that all communications between users are sent and received using the best communication modality based on any relevant factors associated with the sender and recipient of the message.

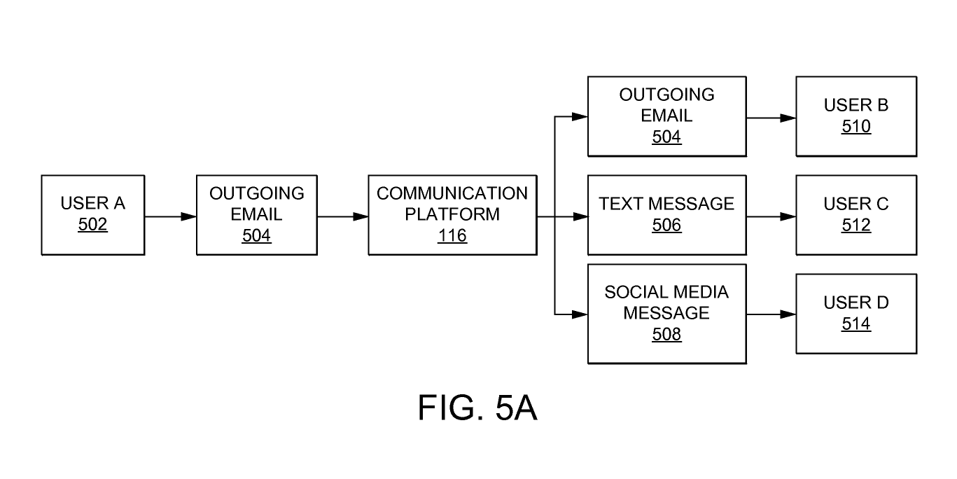

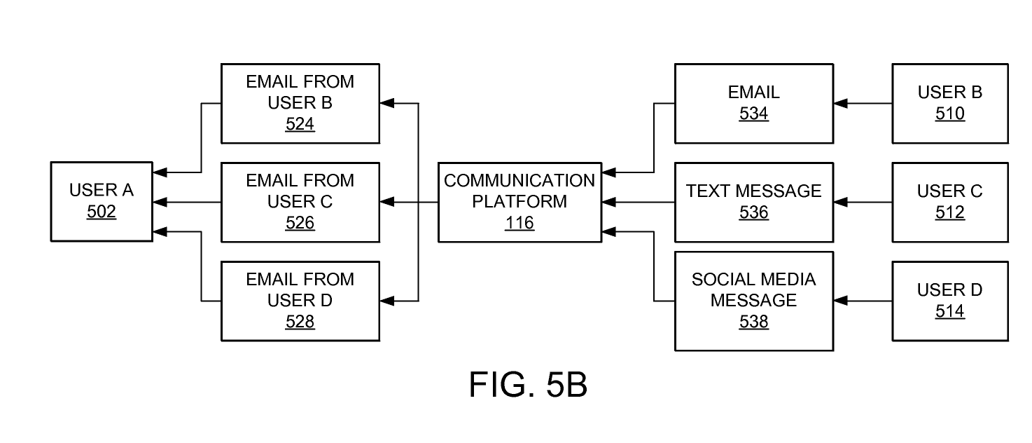

It is to be appreciated that in some embodiments communication platform 116 can be configured for use with group messaging. For example, turning to FIG. 5A, a block diagram of a user A sending a message to a plurality of users using communication platform 116 is shown in accordance with an embodiment of the present disclosure. In FIG. 5A, user A is using computing device 502, which is coupled to communication platform 116, to send a message (outgoing email 504) to users B, C, and D who are receiving the message at computing devices 510, 512, and 514, respectively. It is to be appreciated that, as with previous embodiments, user computing devices 502, 510, 512, and 514 may be any of a number of computing devices such as, but not limited to, a smartphone, personal computer, laptop, and/or tablet.

In FIG. 5A, after user A has composed and sent a desired message in the form of outgoing email 504, communication platform 116 will receive outgoing email 504 and determine, based on contact profiles saved in database 214, what the optimal communication modalities are to send user A's message to users B, C, and D. In group messaging there are often many recipients, and it is possible that each recipient of a message, based on that recipients contact profile, may be optimally reached at a different communication modality. For example, given the time and date, user B may be best reached by email, user C may be best reached by text, and user D may be best reached by a social media message. Communication platform 116 is configured to determine, based on information in database 214, what communication modality is most optimal to reach users B, C, and D. Furthermore, communication platform 116 is configured to convert between communication modality formats as described above in relation to FIGS. 3 and 4.

Therefore, turning again to FIG. 5A, communication platform 116 will receive outgoing email 504 and will determine that user B should be reached by email. Since user A sent the message as an email, communication module 116 does not have to convert the message and the email can be sent to user B and received on computing device 510. Furthermore, communication platform 116 will determine that user C should be reached by text message. Therefore, communication platform 116 will convert outgoing email 504 to a text message 506 containing the same body as outgoing email 504 and text message 506 will be sent to user C, for example, at computing device 512 via cellular network 120. Additionally, communication platform 116 will determine that user D should be reached by a social media message (e.g., a personal message on Facebook or Twitter). Therefore, communication platform 116 will convert outgoing email 504 to a social media message 508 containing the same body as outgoing email 504 and social media message 508 will be sent to user D at computing device 514 via Internet 114.

It is to be appreciated that communication platform 116 may also be used to manage any responses user A receives from users B, C, and D. For example, turning to FIG. 5B, a block diagram of user A receiving responses from users B, C, and D using communication platform 116 is shown in accordance with an embodiment of the present disclosure. FIG. 5B shows user B responding to user A's email 504 with email 534, user C responding to user A's text message 506 with text message 536, and user D responding to user A's social media message 508 with social media message 538. Email 534, text message 536, and social media message 538 are intercepted by communication platform 116, where, as described above, routing module 216 will determine if any of the responses need to be converted to the original communication modality chosen by user A (i.e., email) in formatting module 218.

Referring to FIG. 5B, since user B's response is an email and user A's original message was also an email, communication platform 116 does not need to convert user B's response and user B's email 524 is sent to user A's computing device 502. Since user C's response is a text message and user A's original message was an email, communication platform 116 converts text message 536 to an email 526 and email 526 is sent to user A's computing device 502. Furthermore, since user D's response is a social media message 538 and user A's original message was an email, communication platform 116 converts social media message 538 to an email 528 and email 528 is sent to user A's computing device 502. In this way, from user A's and B's perspectives, the communications have occurred through emails, while from user C's perspective the communications have occurred through text messages, and through user D's perspective the communications have occurred through social media messages.

It is to be appreciated that although communication platform 116 is described above for use in determining the best communication modality to be used to contact a user, in accordance with the present disclosure communication platform 116 may also be used to determine the best contact option within the same communication modality. For example, if a user A sends an email to a user B's work email, communication platform 116 can determine that, based on the date, time and other saved preferences, the most effective way to contact user B is to send the email to user B's personal email address. As a further example, if a user A sends a text message to a user B's work phone, communication platform 116 can determine that, based on the date, time and other saved preferences, the most effective way to contact user B is to send the text message to user B's personal phone.

As stated above, another issue that arises in modern day communications, given the variety of communication modalities that are available to users, is determining whether the content of a message is appropriate based on who the message is sent to, where the message is sent from, and which communication modality is used. In addition to the uses in the above-described embodiments, communication platform 116 can also be used to determine if the content in a message is appropriate to send to another user. Specifically, content filter module 222 (shown in FIG. 2) in communication platform 116 is configured to filter messages sent by a user to determine whether the content of the message is appropriate based on many factors, as will be described below.

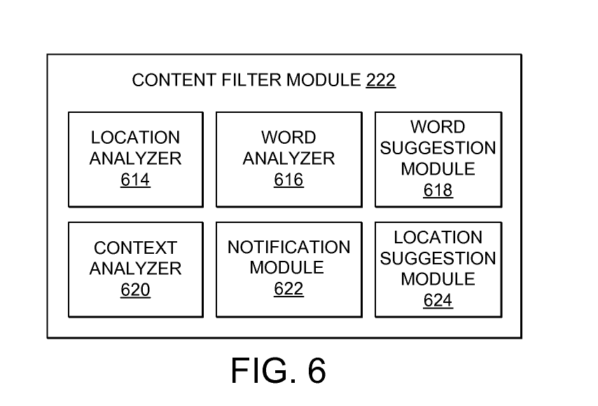

Turning to FIG. 6, a block diagram of content filter module 222 is shown in accordance with an embodiment of the present disclosure. Content filter module 222 includes location analyzer 614, word analyzer 616, word suggestion module 618, context analyzer 620, notification module 622, and location suggestion module 624. It is to be appreciated that the various components of content filter module 222 can access database 214 and write to database 214. Furthermore, as stated above, database 214 contains information associated with user communications. In certain embodiments, database 214 also contains information associated with inappropriate content for communications given many different factors, as will be described below.

In one embodiment, database 214 contains one or more lists of words in each contact profile that are considered objectionable or inappropriate for use in communication with that specific contact. When a user composes a message to be sent, for example by email, word analyzer 616 in content filter module 222 is configured to check database 214 for the contact profile for the intended recipient of the message to check if there are any words in the composed message that are considered objectionable for use in communication with that contact. If an objectionable word is found in the message by word analyzer 616, the message will not be sent and notification module 622 will transmit a notification to the user informing the user that there is inappropriate content in the message and will indicate what the inappropriate content is (i.e., which word or words are inappropriate). Also, it is to be appreciated that, similar to previous embodiments, content filter module 222 may be used to filter inappropriate content for messages transmitted with various user computing devices 122, such as, but not limited to a personal computer, laptop, tablet, and/or a smartphone. Additionally, it is to be appreciated, that, as with previous embodiments, content filter module 222, can be configured to support group messaging (i.e., filtering inappropriate content in group messaging communications).

Furthermore, content filter module 222 also includes word suggestion module 618. Word suggestion module 618 is configured to find alternative words that can be used when word analyzer 616 finds inappropriate or objectionable words in a composed message. It is to be appreciated that in some embodiments word suggestion module 618 includes a thesaurus that can suggest alternative words when word analyzer 616 finds inappropriate or objectionable words in a composed message. If word suggestion module 618 finds alternative words that can be used in the place of objectionable words, notification module 622 will transmit these suggestions to the user.

For example, there may be contact profiles with lists of objectionable words for contacts A, B, and C stored in database 214. For contact A, word 1, word 2, and word 3 may be considered inappropriate for use in communication with contact A. Additionally, for contact B, word 4, word 5, and word 6 may be inappropriate for use in communication with contact B, and for contact C, word 7, word 8, and word 9 may be inappropriate for use in communication with contact C. If a user composes a message to be sent to contacts A, B, and C in a chosen communication modality, for example, an email, word analyzer 616 is configured to check if the message contains any of the objectionable words stored in the contact profiles for contacts A, B, and C. For example, if the users composed email contains word 4, word analyzer will find that the message does not contain any objectionable words for contacts A and C, however, word 4 is objectionable when used in communication with contact B. Therefore, the email will be sent to contacts A and C, but not to contact B. Instead, notification module 622 will transmit a message to the user indicating that the user's composed message contains objectionable content towards user B. Additionally, word suggestion module 618 will determine if any alternative words may be used that are not considered inappropriate for communication with contact B. If word suggestion module 618 finds alternative words, notification module 622 will transmit the suggested words to the user.

It is to be appreciated that in another embodiment, database 214 may also store separate objectionable word lists for multiple contact options of specific users. For example, in contact A's contact profile, there may be a first word list containing words that are inappropriate for use in messages sent to contact A's work email, a second word list containing words that are inappropriate for use in messages sent to contact A's personal email, a third word list containing words that are inappropriate for use in messages sent to contact A's smartphone via text message, and a fourth list containing words that are inappropriate for use in messages sent to contact A's social media account. In this embodiment, if a message is sent to contact A, word analyzer 616 will check, which, if any, of contact A's contact options are appropriate to send the message to based on the words in the message and the words on the various objectionable lists for contact A's contact options.

If a contact option for contact A is found where none of the words in the composed message appear on a word list for that contact option, communication platform 116 will transmit the message to that contact option. It is to be appreciated, that in some embodiments, if there are multiple contact options that may be used for a given message, notification module 622 may transmit a message to the user prompting the user to pick which contact option to use. Alternatively, in other embodiments if there are multiple contact options that may be used for a given message, communication platform 116, may determine as described above, which of the available contact options is the most likely to yield a prompt response from the recipient and communication platform 116 can transmit the message to the determined contact option. However, if the message contains objectionable words for all possible contact options for contact A, notification module 622 will transmit a message to the user indicating that the message contains objectionable content. Additionally, word suggestion module 618 will check if there are alternative words that can be used in place of the objectionable words and transmit the alternative words to the user so the user may edit the message to include more appropriate words.

Although the above embodiments include lists of words that are inappropriate for a specific contact, in yet another embodiment, database 214 may also include lists of words that are inappropriate for use in communication with all contacts that have a specific relation to the user composing the message. The relation to the user composing the message may be stored in database 214 as a “relationship identifier.” For example, for all contacts designated as “friends” in their contact profile (stored in database 214), word 1, word 2, and word 3, may be considered inappropriate for use in communications with contacts who are friends. Additionally, for all contacts designated as “co-workers,” word 3, word 4, and word 5 may be considered inappropriate for use in communications with contacts who are co-workers. It is to be appreciated that the above examples of relationship identifiers are merely exemplary and that many more relationship identifiers may be included for use in accordance with the present disclosure, such as, but not limited to, “family,” “daughter,” “son,” “father,” “boss,” “client,” “teacher,” “classmate,” etc.

Also, it is also to be appreciated, that in some embodiments a list of words may be stored in database 214 that are considered inappropriate for all contacts. For example, word 7, word 8, and word 9 may be stored in database 214 and labeled as inappropriate for use in communication with all contacts. Therefore, if a user were to compose a message containing any of words 7, 8, and/or 9, content filter module 222 would notify the user that the message contains inappropriate content and the message would not be sent.

In some embodiments, content filter module 222 may be configured to filter messages based on topics as well as words. This may be advantageous, because although certain inappropriate words may not be present in a message, a combination of words can describe an inappropriate topic of discussion for communication with a particular contact.

Turning again to FIG. 6, context analyzer 620 is included in content filter module 222. Context analyzer 620 is configured to analyze a composed message to determine if any objectionable or inappropriate topics are contained in the composed message. In some embodiments, context analyzer 620 includes a context aware algorithm to determine the context of a message using various techniques known in the art such as “K topic” processing.

Similar to the lists of objectionable words, lists of objectionable topics may be stored in database 214. The lists of objectionable topics stored in database 214 may pertain to specific contacts or specific contact options of specific contacts as described above in relation to the lists of objectionable words. Additionally, there may be lists of objectionable topics for any contact that has a certain relationship to the user sending the composed message. Furthermore, there may be lists of objectionable topics that are considered objectionable when included in communications with any contact. It is to be appreciated that the above lists of objectionable topics are merely exemplary and many more lists of objectionable topics can be included in database 214 for filtering composed messages.

Furthermore, it is to be appreciated that in some embodiments context analyzer 620 may be configured to analyze the context of specific words in a message. This may be advantageous because certain words may only be inappropriate when used in the certain contexts. Therefore, database 214 may also include lists of words that are inappropriate in certain predetermined contexts. Context analyzer 620 can analyze composed messages to determine if the usage of a word stored in a list of objectionable words is objectionable based on the context of the sentence or paragraph the words appears in.

It is to be appreciated that in some embodiments a user, or a user overseeing another user's account (e.g., a parent or corporation) may create a special word replacement list stored in database 214 to replace specific words based on the determinations of word analyzer 616 and context analyzer 620 instead of relying on the recommendations of word suggestion module 618. For example, user A may have saved user preferences (whether chosen by user A or another user overseeing user A's account) in database 214 that a communication using a specific communication modality (e.g., a work email) including word 1 is inappropriate when used in reference to topic 1, and that when word 1 is used in reference to topic 1, word 1 is automatically to be replaced with word 2 by content filter module 222.

In yet another embodiment, content filter module 222 may be configured to filter specific content (words and topics) sent from a specific location or from a specific device. Content filter module 222 can determine the location of the transmission of a message using location analyzer 614. Location analyzer 614 in content filter module 222 is configured to determine the MAC address of a device and/or the IP address of a device. In database 214, lists of objectionable words and topics may be associated with certain MAC addresses and/or IP addresses of certain devices. In this way, any messages including inappropriate or objectionable words or topics that are sent from devices having certain MAC or IP addresses, as detected by location analyzer 614, can be detected by content filter module 222 and the composing user can be notified via notification module 622 that the message was not sent because it contains objectionable content based on the device being used for transmitting the message.

For example, a user may designate, in database 214, that any messages sent from a work computer or from work are inappropriate if they contain word 1, word 2, word 3, topic 1, topic 2, and/or topic 3. Messages sent from a work computer may be detected using the work computer's MAC address and messages sent from work may be detected using the IP address of the user's work network. It is to be appreciated, that many MAC and IP addresses for locations and devices may be stored in database 214, such as, but not limited to, “home” for communication from devices on a user's home network or “public” for communication from devices on a publicly accessible network.

Also included in content filter module 222 is location suggestion module 624. Location suggestion module 624 is configured to check database 214 for locations from which a message can be sent that would render the content of the message appropriate (i.e., the message would not contain objectionable content for that alternate location). For example, if it is determined by location analyzer 614 that a message contains inappropriate content, based on the location of the device or the device being used to transmit the message, location suggestion module 624 will check database 214 to see if there are other locations or devices that the message can be sent from that would render the content of the message appropriate. If location suggestion module 624 determines there is another location that the message can be sent that would render the message appropriate, notification module 622 will notify the user that the message contains inappropriate content and will prompt the user to send it from the alternative location or device determined by location suggestion module 624.

It is to be appreciated that the words and topics included in the lists of objectionable words and the lists of objectionable topics stored in database 214 may be offensive words or topics. However, it is to be appreciated that the words and topics included in the lists of objectionable words and lists of objectionable topics may also be words or topics containing sensitive information. Furthermore, it is to be appreciated that lists of objectionable content may be based on a combination of words, topics, and the location of the device attempting to send the message in accordance with the present disclosure. For example, words or topics that include confidential work-related information may be stored in database 214 and filtered by content filter module 222 when sent from any device other than a designated work computer. Additionally, the work-related information may be filtered based on the contact the message is sent to. Furthermore, words or topics that include confidential personal information, such as, but not limited to, passwords and credit card information, may be stored in database 214 and filtered by content filter module 222 when sent to certain contacts or when sent from certain locations. For example, confidential personal information may be filtered when transmitted over a public network. It is to be appreciated that all the above described features of content filter module 222 may be combined to form a rich, comprehensive filtering system, to filter words and topics in composed messages in a wide variety of circumstances.

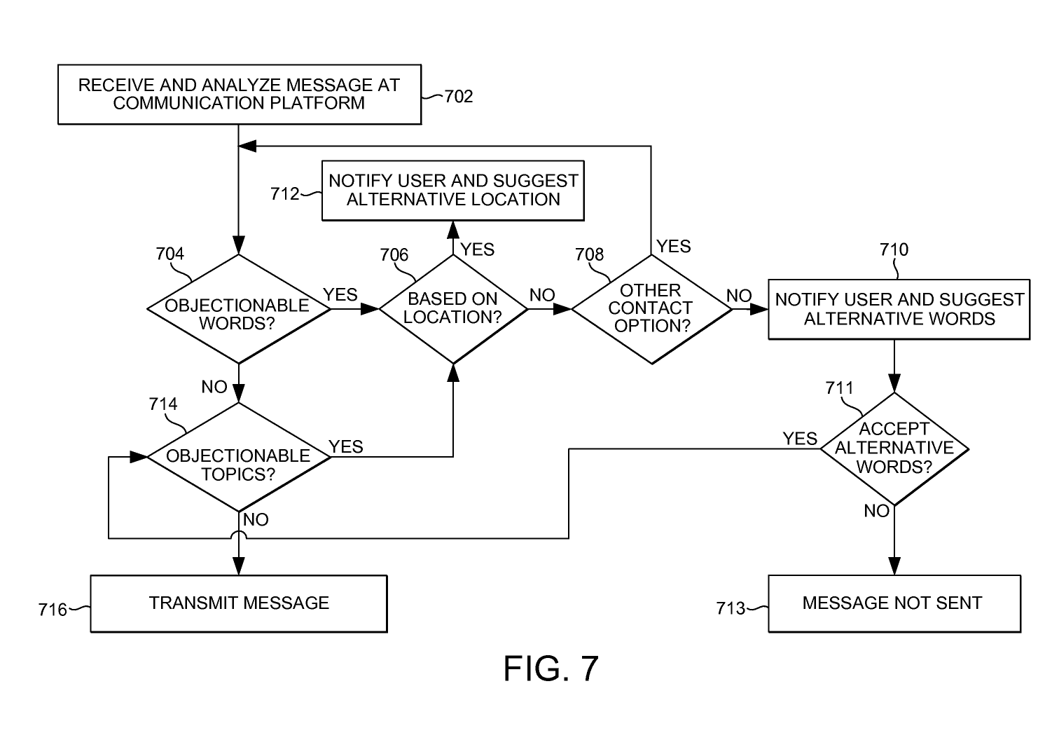

Turning to FIG. 7, an exemplary method for using communication module 222 in communication platform 116 to filter objectionable content (e.g., words and topics) in a message is shown in accordance with an embodiment of the present disclosure. Initially, an outgoing message is composed by user A for user B and transmitted to communication platform 116. The outgoing message is composed on user computing device 122 in a communication modality chosen by user A and sent to one of a plurality of user B contact options. For example, the communication modality may be an email composed on a smartphone and sent to user B's work email address, although it is to be appreciated that many other combinations of user computing devices, communication modalities, and contact options may be used in accordance with the present disclosure.

The composed email is then received at content filter module 222 in communication platform 116 and analyzed to extract or determine at least one parameter, e.g., the currently used communication modality, the intended recipient, originating device, etc., in step 702. In content filter module 222, word analyzer 616 will determine, based on any lists of objectionable words in user B's contact profile in database 214, if the composed email contains any objectionable words, in step 704. It is to be appreciated that in step 704 word analyzer 616 will also check location analyzer 614 to determine user A's location or the specific device user A is using. Next, word analyzer 616 will determine if the objectionable words are based on the location of the user or the device being used, in step 706. If word analyzer 616 determines that the composed email contains objectionable words based on the location of the user or the device being used, notification module 622 will notify user A that the message contains inappropriate content based on the device being used or user A's location, in step 712. Additionally in step 712, location suggestion module 624 will check if there are any alternative locations or devices stored in database 214 that would render the content of the message appropriate and prompt the user to send the message from the alternative device or location.

However, if word/syntax analyzer 616 determines that the objectionable words in the composed email are not based on the location of the user or the device being used, word analyzer 616 will check database 214 to see if there are any other contact options to contact user B, in step 708. If there are no other contact options to contact user B, then word suggestion module 618 will determine if any of the objectionable words can be replaced with alternative words that are not objectionable for the chosen contact option. Then, notification module 622 will transmit a message to user A's computing device 122 notifying user A the message has not been sent because it contains objectionable content, in step 710. Also in step 710, notification module 622 will notify user A of the objectionable words detected and list and alternative words that are not objectionable as determined by word suggestion module 618. However, if word analyzer 616 finds another available contact option for user B in database 214 in step 708, word analyzer 616 will determine for the new contact option if, based on any lists of objectionable words in user B's contact profile in database 214, the composed email contains any objectionable words, in step 704.

Alternatively, after the alternative words are presented to the user in step 710, the user may accept or decline the alternative words, in step 711. If the user accepts the alternative words, then context analyzer 620 will determine if there are any objectionable topics in the composed email, in step 714. However, if the user declines the alternative words in step 711, the message will not be sent, in step 713.

If it is determined by word analyzer 616 that the composed message to be sent to the user B contact option originally chosen by user A does not contain any objectionable words, then context analyzer 620 will determine if there are any objectionable topics in the composed email, in step 714. It is to be appreciated that in step 714 context analyzer 620 will also check location analyzer 614 to determine user A's location or the specific device user A is using. Next, context analyzer 620 will determine if the objectionable topics are based on the location of the user or the device being used, in step 706. If context analyzer 620 determines that the composed email contains objectionable topics based on the location of the user or the device being used, notification module 622 will notify user A that the message contains inappropriate content based on the device being used or user A's location, in step 712. Additionally in step 712, location suggestion module 624 will check if there are any alternative locations or devices stored in database 214 that would render the content of the message appropriate and prompt the user to send the message from the alternative device or location.

However, if context analyzer 620 determines that the objectionable topics in the composed email are not based on the location of the user or the device being used, context analyzer 620 will check database 214 to see if there are any other contact options to contact user B, in step 708. If there are no other contact options to contact user B, then notification module 622 will transmit a message to user A's computing device 122 notifying user A the message has not been sent because it contains objectionable content, in step 710. Also in step 710, notification module 622 will notify user A of the objectionable topics detected. However, if context analyzer 620 finds another available contact option for user B in database 214 in step 708, word analyzer 616 will determine for the new contact option if, based on any lists of objectionable words in user B's contact profile in database 214 if the composed email contains any objectionable words, in step 704.

If context analyzer 620 determines there are no objectionable topics in the composed email, routing module 216 will send the email to the user B contact option chosen originally by use A, in step 716.

It is to be appreciated that when a user A sends a message to user B, communication platform 116 can use the determinations of both profile engine 220 and content filter module 222. For example, if a user A composes and message in the form of a text message to user B, profile engine 220 may determine that given the date and time, user B is most likely to respond in the quickest time interval if user B is contacted by email. Furthermore, profile engine 220 may determine that the second best communication modality for contacting user B is via a social media message and the third best communication modality for contacting user B is via a text message. Before determining which communication modality to use to send user A's message to user B, the message will be filtered in content filter module 222. Content filter module 222, may determine that the content of the message is inappropriate for an email, however the content of the message is appropriate for a social media message and a text message. Using both the determinations of profile engine 220 and content filter module 222, routing module 216 will transmit the message using a social media message because a social media message is the communication modality that is likely to yield the quickest response from user B, while still containing appropriate message content.

It is to be appreciated that the various features shown and described are interchangeable, that is a feature shown in one embodiment may be incorporated into another embodiment.

Although embodiments which incorporate the teachings of the present disclosure have been shown and described in detail herein, those skilled in the art can readily devise many other varied embodiments that still incorporate these teachings. Having described preferred embodiments of a system, apparatus and method for effective communication across a plurality of communication modalities (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure.

What is claimed is:

1. A communication method comprising:
analyzing (305) a communication to be sent from a first user using a first communication modality to at least a second user, the second user having at least a first contact option using the first communication modality and a second contact option using a second communication modality;
determining (306), based on at least a first parameter, if the communication should be transmitted to the first contact option or the second contact option;
transmitting (312) the communication to the first contact option if it is determined that the communication should be sent to the first contact option;
converting (310) the communication from a first format to a second format if it is determined that the communication should be sent to the second contact option, the first format compatible with the first communication modality and the second format compatible with the second communication modality; and
transmitting (312) the communication to the second contact option if it is determined that the communication should be sent to the second contact option.

2. The method of claim 1, wherein the at least first parameter is a time the communication is being sent.

3. The method of claim 1, wherein the at least first parameter is a day of the week the communication is being sent.

4. The method of claim 1, wherein the at least first parameter is a preferred contact option for the second user.

5. The method of claim 1, wherein the determining is based on the at least first parameter and a second parameter.

6. The method of claim 1, wherein the first communication modality and the second communication modality is at least one of a text messaging service, an email service and a social media communication service.

7. The method of claim 1, further comprising:
receiving (402) a responsive communication in the second format from the second user;
converting (408) the responsive communication from the second format to the first format; and
transmitting (410) the responsive communication to the first user.

8. The method of claim 1, wherein the communication is sent to a third user, the third user having at least a third contact option and fourth contact option, the third contact option using the first communication modality and the fourth contact option using the second communication modality.

9. A communication platform (116) comprising:
a routing module (216) that analyzes a communication to be sent from a first user using a first communication modality to at least a second user, the second user having at least a first contact option using the first communication modality and a second contact option using a second communication modality;
the routing module (216) determines, based on at least a first parameter, if the communication should be transmitted to the first contact option or the second contact option and transmits the communication to the first contact option if it is determined that the communication should be sent to the first contact option; and
a formatting module (218) that converts the communication from a first format to a second format if it is determined by the routing module (216) that the communication should be sent to the second contact option, the first format compatible with the first communication modality and the second format compatible with the second communication modality,
wherein the routing module (216) transmits the communication to the second contact option if it is determined by the routing module (216) that the communication should be sent to the second contact option.

10. The communication platform (116) of claim 9, wherein the at least first parameter is a time the communication is being sent.

11. The communication platform (116) of claim 9, wherein the at least first parameter is a day of the week the communication is being sent.

12. The communication platform (116) of claim 9, wherein the at least first parameter is a preferred contact option for the second user.

13. The communication platform (116) of claim 9, wherein the routing module (216) determines if the communication should be transmitted to the first contact option or the second contact option based on the at least first parameter and a second parameter.

14. The communication platform (116) of claim 9, wherein the first communication modality and the second communication modality is at least one of a text messaging service, an email service, and a social media communication service.

15. The communication platform (116) of claim 9, wherein the routing module (216) receives a responsive communication in the second format from the second user, the formatting module (218) converts the responsive communication from the second format to the first format, and the routing module (216) transmits the responsive communication to the first user.

16. The communication platform (116) of claim 9, wherein the communication is sent to a third user, the third user having at least a third contact option and fourth contact option, the third contact option using the first communication modality and the fourth contact option using the second communication modality.

17. A communication method comprising:
analyzing (702) a communication to be sent from a first user to at least a second user, the second user having at least a first contact option and a second contact option;
determining (704, 714) if the communication contains content that would be objectionable to receive at either the first contact option or the second contact option;
transmitting (716) the communication to the first contact option if there is no objectionable content for the first contact option;
transmitting (708) the communication to the second contact option if there is objectionable content for the first contact option and there is not objectionable content for the second contact option;
proposing (710) alternative content if there is objectionable content for the first and second contact options; and
transmitting (716) the communication to at least one of the first and second contact options if the objectionable content is replaced by the alternative content.

18. The method of claim 17, wherein the determining (704) further includes:
retrieving at least a first list of objectionable words from a first profile, the first profile associated with the first contact option;
retrieving at least a second list of objectionable words from a second profile, the second profile associated with the second contact option; and
determining if any of the words in the communication match any of the words included in the first list of objectionable words or second list of objectionable words.

19. The method of claim 18, wherein the first profile contains a first relationship identifier and the second profile contains a second relationship identifier, the first relationship identifier based on the relationship between the first user and the first contact option and the second relationship identifier based on the relationship between the first user and the second contact option.

20. The method of claim 19, wherein the first list of objectionable words are words that are inappropriate for use in communication with a contact option that includes the first relationship identifier and the second list of objectionable words are words that are inappropriate for use in a communication with a contact option that includes the second relationship identifier.

21. The method of claim 17, further comprising:
determining (704, 714) the location of the first user at the time the communication is to be sent from the first user to at least the second user;
determining (704, 714) if the communication contains any content that would be objectionable to send from the location of the first user; and
transmitting (716) the communication to the second user if there is no objectionable content based on the location of the first user.

22. The method of claim 17, further comprising:
determining (704, 714, 706) a first device used by the first user to send the communication to at least the second user;
determining (704, 714, 706) if the communication contains any content that would be objectionable to send from the first device; and
transmitting (716) the communication to the second user if there is no objectionable content based on the first device.

23. The method of claim 17, wherein determining (714) further includes:
retrieving at least a first list of objectionable topics from a first profile, the first profile associated with the first contact option;
retrieving at least a second list of objectionable topics from a second profile, the second profile associated with the second contact option; and
determining if any of the topics in the communication match any of the topics included in the first list of objectionable topics or second list of objectionable topics.

24. The method of claim 23, wherein the first profile contains a first relationship identifier and the second profile contains a second relationship identifier, the first relationship identifier based on the relationship between the first user and the first contact option and the second relationship identifier based on the relationship between the first user and the second contact option.

25. The method of claim 24, wherein the first list of objectionable topics are topics that are inappropriate for use in communication with a contact option that includes the first relationship identifier and the second list of objectionable topics are topics that are inappropriate for use in a communication with a contact option that includes the second relationship identifier.

26. The method of claim 17, wherein the alternative content is a list of words, the list of words generated by a thesaurus.

27. A communication platform (116) comprising:
a content filter module (222) that analyzes a communication to be sent from a first user to at least a second user, the second user having at least a first contact option and a second contact option, determines if the communication contains content that would be objectionable to receive at either the first contact option or the second contact option, transmits the transmission of the communication to the first contact option if there is no objectionable content for the first contact option and transmits the transmission of the communication to the second contact option if there is objectionable content for the first contact option and there is not objectionable content for the second contact option; and
a word suggestion module (618) that proposes alternative content if there is objectionable content for the first and second contact options,
wherein the content filter module (222) transmits the communication to at least one of the first and second contact options if the objectionable content is replaced by the alternative content.

28. The communication platform (116) of claim 27, further comprising:
a word analyzer (616) that retrieves at least a first list of objectionable words from a first profile, the first profile associated with the first contact option, retrieves at least a second list of objectionable words from a second profile, the second profile associated with the second contact option and determines if any of the words in the communication match any of the words included in the first list of objectionable words or second list of objectionable words.

29. The communication platform (116) of claim 28, wherein the first profile contains a first relationship identifier and the second profile contains a second relationship identifier, the first relationship identifier based on the relationship between the first user and the first contact option and the second relationship identifier based on the relationship between the first user and the second contact option.

30. The communication platform (116) of claim 29, wherein the first list of objectionable words are words that are inappropriate for use in communication with a contact option that includes the first relationship identifier and the second list of objectionable words are words that are inappropriate for use in a communication with a contact option that includes the second relationship identifier.

31. The communication platform (116) of claim 27, further comprising:
a location analyzer (614) that determines the location of the first user at the time the communication is to be sent from the first user to at least the second user, wherein the content filter module (222) determines if the communication contains any content that would be objectionable to send from the determined location of the first user and permits the transmission of the communication to the second user if there is no objectionable content based on the determined location of the first user.

32. The communication platform (116) of claim 27, further comprising:
a location analyzer (614) that determines a first device used by the first user to send the communication to at least the second user, wherein the content filter module (222) determines if the communication contains any content that would be objectionable to send from the first device and permits the transmission of the communication to the second user if there is no objectionable content based on the first device.

33. The communication platform (116) of claim 27, further comprising:
a context analyzer (620) that retrieves at least a first list of objectionable topics from a first profile, the first profile associated with the first contact option, retrieves at least a second list of objectionable topics from a second profile, the second profile associated with the second contact option and determines if any of the topics in the communication match any of the topics included in the first list of objectionable topics or second list of objectionable topics.

34. The communication platform (116) of claim 33, wherein the first profile contains a first relationship identifier and the second profile contains a second relationship identifier, the first relationship identifier based on the relationship between the first user and the first contact option and the second relationship identifier based on the relationship between the first user and the second contact option.

35. The communication platform (116) of claim 34, wherein the first list of objectionable topics are topics that are inappropriate for use in communication with a contact option that includes the first relationship identifier and the second list of objectionable topics are topics that are inappropriate for use in a communication with a contact option that includes the second relationship identifier.

36. The communication platform (116) of claim 27, wherein the alternative content is a list of words, the list of words generated by a thesaurus.
